(19) United States
(12) Patent Application Publication
(10) Pub. No.: US 2011/0082225 A1
(43) Pub. Date: Apr. 7, 2011

(54) THERMOPLASTIC ELASTOMERS EXHIBITING SUPERIOR ABRASION RESISTANCE PROPERTIES

(75) Inventors: Guoqiang Qian, Buffalo Grove, IL (US); Krishna Venkataswamy, Crystal Lake, IL (US)

(73) Assignee: POLYONE CORPORATION, Avon Lake, OH (US)

(21) Appl. No.: 12/997,335

(22) PCT Filed: Jun. 16, 2009
(86) PCT No.: PCT/US09/47538

§ 371 Date: Dec. 10, 2010

Related U.S. Application Data
(60) Provisional application No. 61/073,310, filed on Jun. 17, 2008.

(51) Int. Cl. C08L 53/00; C08K 3/34; C08K 3/24; C08K 5/101; A01P 1/00; A01P 3/00

(52) U.S. Cl. 521/139; 525/89; 524/505; 523/122; 524/449; 524/442; 524/413; 524/318

(57) ABSTRACT

A blend of thermoplastic polyester elastomer, hydrogenated styrenic block copolymer, and high styrene content styrenic block copolymer is disclosed which has good processability and more effective abrasion resistance than the blend using polystyrene in place of the high styrene content styrenic block copolymer.

### CLAIM OF PRIORITY

This application claims priority from U.S. Provisional Patent Application Ser. No. 61/073,310 bearing Attorney Docket Number 12008016 and filed on Jun. 17, 2008, which is incorporated by reference.

### FIELD OF THE INVENTION

This invention relates to thermoplastic polyester elastomers containing styrenic block copolymers to provide superior abrasion resistance properties.

### BACKGROUND OF THE INVENTION

The world of polymers has progressed rapidly to transform material science from wood and metals of the 19^{th} Century to the use of thermoset polymers of the mid-20^{th} Century to the use of thermoplastic polymers of later 20^{th} Century.

Thermoplastic elastomers (TPEs) combine the benefits of elastomeric properties of thermoset polymers, such as vulcanized rubber, with the processing properties of thermoplastic polymers. Therefore, TPEs are preferred because they can be made into articles using injection molding equipment. But often, TPEs lack abrasion resistance properties for some demanding applications, such as high end tools, etc.

### SUMMARY OF THE INVENTION

What the art needs is a new formulation of thermoplastic elastomer (TPE) that has superior abrasion resistance properties.

The present invention solves that problem by using a TPE formulation that includes a blend of elastomers, along with optional or conventional ingredients. This formulation has superior abrasion resistance properties as measured using the Taber Abrasion test (ASTM method D3389-05).

For purposes of this invention, the following terms are defined.

“Thermoplastic polyester elastomer” means a thermoplastic elastomer which contains a block copolymer of a hard segment of polyester and a soft segment of long chain polyether glycols. Properties are determined by the ratio of hard to soft segments. They have great affinity to polar substrates and can be used in overmolding applications

“Hydrogenated styrenic block copolymer” means a styrenic block copolymer elastomer in which mid-blocks of butadiene have been hydrogenated, thereby converting a styrene-butadiene-styrene (SBS) block terpolymer into a styrene-ethylene/butylene-styrene (SEBS) block terpolymer.

“High styrene styrenic block copolymer” means a styrenic block copolymer (SBS) elastomer in which the styrene content in all blocks exceeds about 45 weight percent of the copolymer, desirably exceeds about 55 weight percent of the copolymer, and preferably exceeds about 65 weight percent of the copolymer.

One aspect of the invention is a thermoplastic elastomer compound, comprising a blend of (a) thermoplastic polyester elastomer, (b) hydrogenated styrenic block copolymer, and (c) high styrene styrenic block copolymer.

Features of the invention will become apparent with reference to the following embodiments.

### EMBODIMENTS OF THE INVENTION

Blend of Elastomers

Each of the three following elastomers has been found important to the construction of the formulations of the present invention, in order to provide superior abrasion resistance.

Thermoplastic Polyester Elastomer

Any thermoplastic elastomer is a candidate for use in the present invention. This elastomer relies upon the presence of a soft long chain polyether glycol segment to provide tensile elongation of at least 100%.

Elastomers which contain copolyesters are often used for the following purposes: protective boots in automotive suspension joints, house and tubing, rail road draft gear, breathable film, wire and cable, etc.

Non-limiting commercially available thermoplastic polyester elastomers include Hytral brand elastomer from Dupont of Wilmington, Del., Arnitel brand elastomers from DSM, Evansville, Ind., and Skypel brand polyester elastomers from SK Chemicals of Seoul, Korea.

Hydrogenated Styrenic Block Copolymer

Any hydrogenated styrenic block copolymer is a candidate for use in the present invention. This elastomer relies upon the presence of a soft segment of midblock to provide tensile elongation of at least 100%.

Elastomers which contain hydrogenated mid-blocks are often used for the following purposes: food packaging, consumer products, automotive, etc.

Non-limiting commercially available hydrogenated styrenic block copolymers include Kraton brand copolymers from Kraton Polymers of Houston, Tex., and Septon brand copolymer from Septon of Pasadena, Tex., USA.

High Styrene Styrenic Block Copolymer

Any high styrene styrenic block copolymer is a candidate for use in the present invention. This elastomer relies upon the presence of a soft butylene block to provide tensile elongation of at least 100%.

Elastomers which contain high styrene content are often used for the following purposes: clear food packaging, impact modification of polystyrene, etc.

Non-limiting commercially available high styrene styrenic block copolymers include Stryoflex and Styrolux brand copolymers from BASF of Florham Park, N.J., USA, K Resin brand copolymers from ChevronPhillips of The Woodlands, Tex., USA, and Kraton brand copolymers from Kraton Company, of Houston, Tex., USA.

Other Ingredients

Typically, commercial grades of thermoplastic elastomers are a complex combination of the elastomeric polymers, plasticizer, processing aid (mold release or slip agent), filler, antioxidant, and one or more additional polymers such as a thermoplastic vulcanizate or a hydrocarbon resin. As shown in the examples below, these other ingredients can be included in formulations of the present invention, though not specifically because of performance in abrasion testing. Therefore, for purposes of the present invention, abrasion resistance resides in the selection of the three types of thermoplastic elastomers to be blended together, not the other ingredients.

Other Optional Additives

The compound of the present invention can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; oils and plasticizers; processing aids; release agents; silanes, titanates and zirconates; slip and anti-blocking agents; stabilizers; stearates; ultraviolet light absorbers; viscosity regulators; waxes; and combinations of them.

Table 1 shows the acceptable and desirable ranges of ingredients for the thermoplastic elastomer of the present invention. All but the three thermoplastic elastomers are optional for the present invention and thereby depend on particular compounding performance or processing desires.

TABLE 1
Ranges of Ingredients

| Ingredient | | | |
|---|---|---|---|
| (Wt. Percent) | Acceptable | Desirable | Preferred |
| Thermoplastic | 5-33% | 10-20% | 11-14% |
| polyester elastomer | | | |
| Hydrogenated styrenic | 5-33% | 10-15% | 9-13% |
| block copolymer | | | |
| High styrene styrenic | 5-33% | 10-20% | 11-14% |
| block copolymer | | | |
| Plasticizer | 0-70% | 15-30% | 20-25% |
| Other Polymer(s) | 0-50% | 10-30% | 20-30% |
| Processing Aid-Mold | 0-2% | 0.2-1% | 0.5% |
| Release | | | |
| Filler | 0-40% | 10-20% | 14-16% |
| Anti-oxidant | 0-1% | 0.05-0.2% | 0.08% |
| Other Optional | 0-10% | 0-10% | 0-10% |
| Additives | | | |

Processing

The preparation of compounds of the present invention is uncomplicated. The compound of the present can be made in batch or continuous operations.

Mixing in a continuous process typically occurs in an extruder that is elevated to a temperature that is sufficient to melt the polymer matrix with addition either at the head of the extruder or downstream in the extruder of the solid ingredient additives. Temperatures exceed the melting temperatures of the thermoplastic elastomers to permit good dispersion of all ingredients into the blend, usually more than 210° C. Extruder speeds can range from about 50 to about 500 revolutions per minute (rpm), and preferably from about 400 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit addition of the solid ingredient additives. The mixing speeds range from 60 to 1000 rpm and temperature of mixing needs to be at least 210° C. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

### Usefulness of the Invention

Thermoplastic elastomers of the present invention are particularly suitable for any use in which shearing or other frictional actions are expected to occur during use. The surface of the molded or extruded plastic articles made from the thermoplastic elastomers of the present invention can have Taber abrasion numbers ranging from about 0.5 to about 40, and preferably from about 1 to about 10 mg.

As such, and with the particular advantage of being capable of being injection molded, plastic articles can be made from formulations of the present invention for such uses as seals, closures, and other articles previously made from thermoset rubber or thermoplastic vulcanizates.

Other articles can be made from the thermoplastic elastomers of the present invention, include the following industrial and consumer products: food and drink container seals, printer cartridge seals, medical container seals, shoe soles, hand tools, hoses, gaskets, grommets, gloves, and other products needing both flexibility and abrasion resistance properties, as a suitable replacement for rubber.

### EXAMPLES

Table 2 shows four examples of the present invention, in comparison with a control (Comparative Example A).

All formulations of Examples 1-4 and Comparative Example A had the ingredients in similar proportions in weight percents, except that Comparative Example A used a polystyrene, commonly used in thermoplastic elastomers, whereas Examples 1-4 used a high styrene styrenic block copolymer.

TABLE 2

| Ingredient Name and Source | 1 | 2 | 3 | 4 | Comp. A |
|---|---|---|---|---|---|
| Skypel G130D copolyester (SK Chemicals, Seoul, Korea) | 11.91% | 13.25% | 11.57% | 11.57% | 11.57% |
| Septon 4055 hydrogenated styrene block copolymer (Septon, Pasadena, TX) | 11.31% | 9.94% | 12.14% | 12.14% | 12.14% |
| Calsol 5550 plasticizer (Calumet, Indianapolis, IN) | 22.63% | 19.88% | 24.29% | 24.29% | 24.29% |
| Vicron 25-11 calcium carbonate filler (Specialty Minerals, Bethlehem, PA) | 16.08% | 14.58% | 15.03% | 15.03% | 15.03% |
| Levapren 400 ethylene vinyl acetate (Lanxess, Pittsburgh, PA) | 8.34% | 9.28% | 8.10% | 8.10% | 8.10% |
| Santoprene RC8001 thermoplastic vulcanizate (ExxonMobil Advanced | 11.91% | 13.25% | 11.57% | 11.57% | 11.57% |
| Elastomer Systems, Akron, OH) | | | | | |
| Plastolyn 290 hydrocarbon resin (Eastman Chemicals, Kingsport, TN) | 5.36% | 5.96% | 5.20% | 5.20% | 5.20% |
| Styrolux 3G55 styrenic block copolymer (BASF, Florham Park, NJ) | 11.91% | | | | |
| Styroflex 2G66 styrenic block copolymer (BASF) | | 13.25% | | | |
| K Resin KR03 styrenic block copolymer (ChevronPhilips, Woodlands, TX) | | | 11.57% | | |
| Kraton MD6459 styrenic block copolymer (Kraton Polymers, Houston TX) | | | | 11.57% | |
| PS NVA3190 polystyrene (Ineos Nova, Calgary, Alberta, Canada) | | | | | 11.57% |
| Kemamide B mold slip aid (Crompton, Middlebury, CT) | 0.48% | 0.53% | 0.46% | 0.46% | 0.46% |
| Irganox 1010 antioxidant (Ciba Specialty Chemicals, Terrytown, NY) | 0.08% | 0.09% | 0.08% | 0.08% | 0.08% |

All of Examples 1-4 and A were made using a twin-screw extruder set at 216° C. (420° F.) in all zones, rotating at 400 rpm. All ingredients were added before Zone 1. The melt-mixed compound was pelletized for further handling.

Pellets of all Examples 1-4 and A were molded into tensile test bars using a Demag injection molding machine, operating at 230° C. temperature and high pressure.

Table 3 shows experimental results.

TABLE 3

| Physical Property | 1 | 2 | 3 | 4 | Comp. A |
|---|---|---|---|---|---|
| Shore A Hardness | 62 | 56 | 62 | 61 | 64 |
| (ASTM D2240, 10 s | | | | | |
| delay) | | | | | |
| Specific Gravity | 1.05 | 1.05 | 1.05 | 1.06 | 1.05 |
| (ASTM D792) | | | | | |
| Tensile Strength, psi | 449 | 571 | 421 | 424 | 454 |
| (ASTM D412, Die C) | | | | | |
| Elongation, % | 543 | 732 | 500 | 552 | 232 |
| (ASTM D412, Die C) | | | | | |
| Peel Strength (pli) | 20 | 19 | 18 | 22 | 13 |
| Taber Abrasion | 3.3 | 1.2 | 1.7 | 6 | 256 |
| Resistant (mg) | | | | | |
| (ASTM D3389-05) | | | | | |

Table 3 shows the physical properties of Examples 1-4 and Comparative Example A are comparable or manageable for Shore A hardness, Specific Gravity, Tensile Strength, Percent Elongation, and Peel Strength for use in a two-component molded article wherein the other molded polymer is acrylonitrile-butadiene-styrene (ABS).

What is totally unexpected is the tremendous reduction in abrasion as measured according to the Taber Abrasion test of ASTM 3389-05. Each of Examples 1-4 is forty-three times better than Comparative Example A. Examples 2 and 3 are at least two orders of magnitude better than Comparative Example A.

Not being limited to a particular theory, it is believed that the replacement of polystyrene with a high styrene styrenic block copolymer provides cohesive strength within a material, as well as improved elasticity, which is not capable of being provided by polystyrene alone. Contributing to the unexpectedness of the invention is the fact that the ultimately high styrene styrenic block copolymer would be polystyrene itself. Therefore, the styrene content of the high styrene styrenic block copolymer needs to be more than about 45 weight percent, and preferably more than about 55 weight percent, but still be a SBS copolymer having a butadiene mid-block.

Using Examples 1-4 and other explanations of the present invention in this document, one of ordinary skill in the art, without undue experimentation, will be able to formulate to achieve the appropriate balance of physical processing and physical performance properties while at the same time achieving extraordinarily and unexpectedly superior abrasion resistance properties.

The invention is not limited to the above embodiments. The claims follow.

What is claimed is:

1. A thermoplastic elastomer compound, comprising:
a blend of
(a) thermoplastic polyester elastomer,
(b) hydrogenated styrenic block copolymer, and
(c) high styrene styrenic block copolymer.

2. The compound of claim 1, further comprising plasticizer oil.

3. The compound of claim 1 or claim 2, further comprising filler.

4. The compound of claim 1, further comprising additives selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; oils and plasticizers; processing aids; additional polymers, release agents; silanes, titanates and zirconates; slip and anti-blocking agents; stabilizers; stearates; ultraviolet light absorbers; viscosity regulators; waxes; and combinations of them.

5. The compound of claim 1, wherein the thermoplastic polyester elastomer comprises from about 5 to about 33 weight percent of the compound, wherein the hydrogenated styrenic block copolymer comprises from about 5 to about 33 weight percent of the compound, and wherein the high styrene styrenic block copolymer comprises from about 5 to about 33 weight percent of the compound.

6. The compound of claim 1, wherein the styrene content of the high styrene styrenic block copolymer is at least about 45 weight percent of the styrenic block copolymer.

7. A molded article, comprising a compound of claim 1.

8. A method of using the compound of claim 1, wherein the method comprises the step of molding the compound into an article that has more than about 43 times improvement in abrasion resistance, as measured using ASTM D3389-05), than a compound which has the same thermoplastic polyester elastomer and the same hydrogenated styrenic block copolymer but polystyrene in place of high styrene styrenic block copolymer.

9. The compound of claim 2, further comprising filler.

10. The compound of claim 2, further comprising additives selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; oils and plasticizers; processing aids; additional polymers, release agents; silanes, titanates and zirconates; slip and anti-blocking agents; stabilizers; stearates; ultraviolet light absorbers; viscosity regulators; waxes; and combinations of them.

11. The compound of claim 2, wherein the thermoplastic polyester elastomer comprises from about 5 to about 33 weight percent of the compound, wherein the hydrogenated styrenic block copolymer comprises from about 5 to about 33 weight percent of the compound, and wherein the high styrene styrenic block copolymer comprises from about 5 to about 33 weight percent of the compound.

12. The compound of claim 2, wherein the styrene content of the high styrene styrenic block copolymer is at least about 45 weight percent of the styrenic block copolymer.

13. The compound of claim 3, further comprising additives selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; oils and plasticizers; processing aids; additional polymers, release agents; silanes, titanates and zirconates; slip and anti-blocking agents; stabilizers; stearates; ultraviolet light absorbers; viscosity regulators; waxes; and combinations of them.

14. The compound of claim 3,
wherein the thermoplastic polyester elastomer comprises from about 5 to about 33 weight percent of the compound,
wherein the hydrogenated styrenic block copolymer comprises from about 5 to about 33 weight percent of the compound,
wherein the high styrene styrenic block copolymer comprises from about 5 to about 33 weight percent of the compound, and wherein the styrene content of the high styrene styrenic block copolymer is at least about 45 weight percent of the styrenic block copolymer, and
wherein the styrene content of the high styrene styrenic block copolymer is at least about 45 weight percent of the styrenic block copolymer.

15. The molded article of claim 7, wherein the compound further comprises plasticizer oil.

16. The molded article of claim 7, wherein the compound further comprises filler.

17. The molded article of claim 7, wherein the compound further comprises additives selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; oils and plasticizers; processing aids; additional polymers, release agents; silanes, titanates and zirconates; slip and anti-blocking agents; stabilizers; stearates; ultraviolet light absorbers; viscosity regulators; waxes; and combinations of them.

18. The molded article of claim 7, wherein the thermoplastic polyester elastomer in the compound comprises from about 5 to about 33 weight percent of the compound, wherein the hydrogenated styrenic block copolymer comprises from about 5 to about 33 weight percent of the compound, and wherein the high styrene styrenic block copolymer comprises from about 5 to about 33 weight percent of the compound.

19. The molded article of claim 7, wherein the styrene content of the high styrene styrenic block copolymer in the compound is at least about 45 weight percent of the styrenic block copolymer.

20. The method of claim 8, wherein the compound further comprises plasticizer oil and filler.
